(19) United States
(12) Patent Application Publication
(10) Pub. No.: US 2004/0027490 A1
(43) Pub. Date: Feb. 12, 2004

(54) Ring triggered mute

(75) Inventor: Willem Bulthuis, Portola Valley, CA (US)

Correspondence Address: Corporate Patent Counsel, Philips Electronics North America Corporation, 1000 West Maude Avenue, Sunnyvale, CA, 94085, US

(73) Assignee: KONINKLIJKE PHILIPS ELECTRONICS N.V.

(21) Appl. No.: 10/215,675

(22) Filed: Aug. 9, 2002

(51) Int. Cl. H04N 3/24

(52) U.S. Cl. 348/632

(57) ABSTRACT

A mute trigger apparatus includes a transducer, a database, a processor, a comparator and a mute switch. The transducer is responsive to acoustic wave energy to develop a first electrical signal commensurate with said acoustic wave energy. The database contains stored signal data. The processor is responsive to the first electrical signal to develop dynamic signal data. The comparator is responsive to each of the stored signal data and the dynamic signal data to develop a second electrical signal in the event the stored signal data and the dynamic signal data are substantially equivalent. The mute switch has an off state and an on state. The mute switch is normally biased in its off state and transitionable to its on state in response to the second electrical signal.

### FIELD OF THE INVENTION

The present invention relates generally to muting of audio output and more particularly to muting triggered in response to momentary acoustic energy.

### BACKGROUND OF THE INVENTION

Known prior art devices exist that provide muting of an audio output of audio and video equipment in response to momentary acoustic energy. More particularly, the known prior art devices provide for the automatic muting of a television upon detection of the ringing of a nearby telephone.

The known prior art devices take advantage of the infrared link used to establish communication between a remote control device and the audio or video equipment. Generally, upon pressing a key or button on the remote control device, a respective electronic code for such button is developed and transmitted as an infrared signal to a receiver at the audio or video equipment. The receiver, in response to the received infrared signal, extracts the electronic code and a processor at the equipment performs the function indicated by the extracted code.

For example, the remote control device supplied with a television set may provide buttons or keys, and the respective code generation, for the ON-OFF, channel selection, volume and selective muting functions to be performed at the television set. A disadvantage and limitation of such remote control devices is that the remote control device requires positive actuation by an operator either to initiate or to terminate the muting of the sound from the television set. Accordingly, the muting function cannot be automatically triggered upon detection of a momentary sound, such as the ring emanating from a telephone.

As described in DE 198 34 147 A, this disadvantage and limitation may be overcome by equipping the telephone with a code generator and infrared transmitter. Upon a ring signal being received by the telephone set, the code generator is programmed to develop a code that matches the code generated in a remote control device supplied with a nearby television set for the mute function. The generated code is then transmitted as an infrared signal where it is detected by the receiver at the nearby television set. The television set may then extract the code and utilize such code to mute the audio output as if it was received its own the remote control device supplied with the television set.

A disadvantage and limitation of such prior art device is that the code used for the mute function may vary for each manufacturer of audio and video equipment. Accordingly, the prior art device installed at the telephone needs to be made specific for the brand of audio or video equipment to be controlled.

This particular disadvantage and limitation may be obviated by providing the prior art device with a code database that contains the mute codes for various brands of audio and video equipment. As describe in U.S. Pat. No. 5,128,987, a prior art devices contains a code database that allows multiple devices to be used throughout a location that contains a single telephone line.

As described therein, a residence may have several rooms each equipped with a television and telephone set with the single telephone line common to each room. The prior art device in each room is connected to the telephone line and programmed to generate a code for the brand of television set in the same room by user selection from the code database. When a ring signal is present on the telephone line, the prior art device in each room then generates a mute code for the respective television set in the same room and transmits the code as an infrared signal, which is detected by such television set.

Accordingly, the same prior art device may be used with audio and video equipment of various manufacturers. However, a disadvantage and limitation of such device is that subsequently designed audio and video equipment may utilize mute codes not contained in the code database of the prior art device, thereby rendering it inoperable for such new equipment.

Moreover, wireless cellular telephones have become very common and in many instances have not only supplemented landline telephones but have replaced them. For example, a cellular phone subscriber in an office environment would supplement the landline office telephones with the cellular service to make and receive personal calls, especially where office telephone sets are monitored or metered. However, such cellular customer may also rely on the cellular service to not only supplement but also replace landline residential telephone service.

The prior art devices discussed above are disadvantageously limited in the their use with cellular telephones since each must detect the ring single occurring on a landline. Without a landline on which a ring signal can be detected, the known apparatus or method is incapable of triggering a mute in the presence of a ringing cellar telephone.

Furthermore, a motorist may have a need to automatically mute the vehicle's sound system in order to converse on a received cellular telephone call. Although prior art muting devices for vehicle applications are known to exist, such devices relay on the cellular telephone being integrated into the vehicles sound system such that a ring signal generated internally within the cellular telephone set in response to an incoming call can be detected by the vehicle's sound system electronics to trigger a mute, similarly to detecting a ring signal on a landline, as discussed above. Accordingly, a disadvantage and limitation of such vehicle prior art devices is that they are they are only capable of use with a specially equipped cellular telephone supplied to and resold by the vehicle manufacturer. However, most cellular telephone customers carry commodity telephones for use in their vehicles that are incapable of being integrated into the vehicle's electronics.

Accordingly, there exists a need for a ring triggered mute apparatus and method that overcomes the disadvantages and limitations of the prior art. There also exist a need for a ring triggered mute apparatus and method that is useful in both stationary and mobile applications.

### SUMMARY OF THE INVENTION

It is therefore an object of the present invention that overcomes one or more disadvantages and limitations of the prior art.

It is an important object of the present invention that obviates the need for a mute trigger apparatus to be connected to a landline.

It is also an object of the present invention to provide a mute trigger apparatus and method that is responsive to various sounds.

According to the present invention, a mute trigger apparatus includes a transducer, a database, a processor, a comparator and a mute switch. The transducer is responsive to acoustic wave energy to develop a first electrical signal commensurate with said acoustic wave energy. The database contains stored signal data. The processor is responsive to the first electrical signal to develop dynamic signal data. The comparator is responsive to each of the stored signal data and the dynamic signal data to develop a second electrical signal in the event the stored signal data and the dynamic signal data are substantially equivalent. The second electrical signal is adapted to trigger a mute switch.

In another embodiment of the present invention, an audio apparatus includes a mute switch and an audio output amplifier. The mute switch has an OFF state and an ON state. The audio output amplifier amplifies a low level audio input signal to develop an amplified audio output signal when the mute switch is in its OFF state and mutes the audio output signal when the mute switch is in its ON state. The audio apparatus further includes a mute trigger apparatus including a transducer responsive to acoustic wave energy to develop a first electrical signal commensurate with the acoustic wave energy, a database containing stored signal data, a processor responsive to the first electrical signal to develop a dynamic signal data from the first electrical signal, and a comparator responsive to the dynamic signal data and the stored signal data to develop a second electrical signal in the event the dynamic signal data is substantially equivalent to the stored signal data. The mute switch transitions to its on state in response to the second electrical signal.

A feature of the present invention is that the detected sound to trigger the mute is compared with stored sounds in a database. Accordingly, the present invention advantageously eliminates the need to connect to landlines or to provide integrated cellular telephones, as required by the prior art. Furthermore, the present invention advantageously provides for the detection of multiple sounds, and not just a ring signal on a landline as required by the prior art.

Further advantages of the present invention include the ability of the second electrical signal, although normally adaptable to trigger a mute switch, is readily adaptable to trigger other types of devices. For example, in response to the second signal a text message or icon on a television or other screen may be displayed or the audio equipment itself can generate a ring tone either through a tone generator or through using the stored tone in the database. The normal audio may be muted simultaneously with the generation of the ring tone. Messages may also be developed and sent over a LAN in response to the second electrical signal.

These and other objects, advantages and features of the present convention will become readily apparent to those skilled in the art from a reading of the Description of the Exemplary Preferred Embodiments when read in conjunction with the attached Drawing and appended claims.

### BRIEF DESCRIPTION OF THE DRAWING

FIG. 1 is a schematic block diagram of an apparatus constructed according to the principles of the present invention;

FIG. 2A is a flowchart useful to describe an exemplary method according to the principles of the present invention; and

FIG. 2B is a flowchart of exemplary steps of a method step of FIG. 2A.

### DESCRIPTION OF THE EXEMPLARY PREFERRED EMBODIMENTS

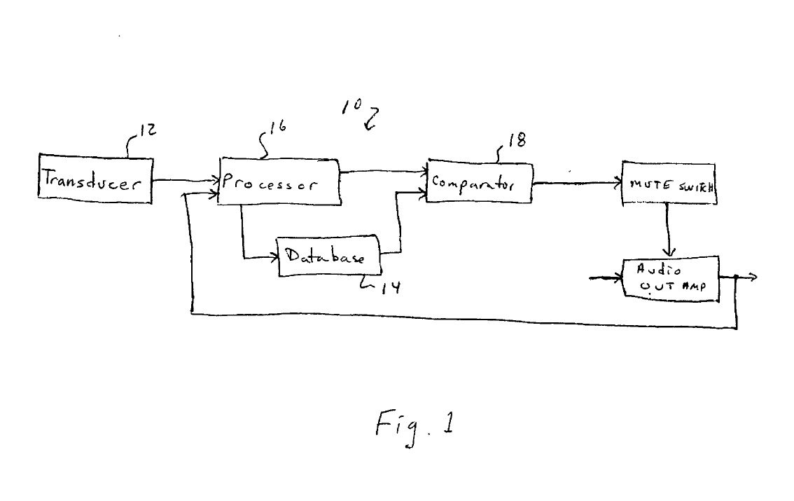

Referring now to FIG. 1, there is shown a mute trigger apparatus 10. The mute trigger apparatus 10 includes a transducer 12, the database 14, a processor 16 and a comparator 18.

The transducer 12 is responsive to acoustic wave energy. In response to such acoustic wave energy, the transducer 12 develops a first electrical signal commensurate with the acoustic wave energy.

The first electrical signal is applied to the processor 16. The processor 16, being responsive to the first electrical signal, develops dynamic signal data. The dynamic signal data, and stored signal data contained in the database 14, is applied to comparator 18. In the event the stored signal data and the dynamic signal data presently applied to comparator 18 are substantially equivalent, the comparator 18 develops a second electrical signal. The second electrical signal is adapted to trigger a conventional mute switch.

For example, audio equipment may include a mute switch 20 and an audio output amplifier 22 that amplifies a low level audio input signal, amplifies the audio input signal and applies an amplified audio output signal to a speaker (not shown). The mute switch 20 has an OFF state and an ON state. The mute switch 20 is normally biased in its OFF state and transitionable to its ON state in response to the second electrical signal developed by the comparator 18.

When the second electrical signal developed by the comparator 18 is applied to the mute switch 20, the mute switch 20 is placed in its ON state. As is conventionally known, the mute switch 20 applies a signal representative of its ON state to the audio amplifier 22. The audio amplifier 22 in response thereto, also as is conventionally known, mutes the audio output. For example, the signal representative of an ON state may cause the gain of the audio amplifier approach unity such that the low level audio input signal is not appreciably amplified. Accordingly, the audio output signal applied to the speaker does not result in an audible sound.

The acoustic wave energy detected by the transducer 12 may also include continuous wave energy and momentary wave energy. For purposes of the present disclosure, they continuous wave energy may include the desired sound output provided by the audio output amplifier 22 when played through a speaker. The momentary wave energy may include the sound of a ringing telephone, including any of the variations provided in landline and cellular telephones, the sound of a doorbell, and any other momentary sound. Even spoken commands such as “mute on” may be included as part of the momentary wave energy.

In one embodiment of the present invention, the continuous wave energy is subtracted from the total acoustic wave energy detected by the transducer 12. By providing for such subtraction, the dynamic signal data would then contain information substantially of only the momentary wave energy.

For example, the low level audio input signal applied to the audio output amplifier 22, may be applied by a feedback loop to the processor 16. The processor 16 may then subtract the audio input signal, representing the continuous wave energy, from the first electrical signal developed by the transducer 12 representing the total acoustic wave energy, thereby resulting in a signal representative of only the momentary wave energy. After subtraction, the processor may then develop a dynamic signal data for comparison to the stored signal data in the database 14.

By using the low level audio input signal for subtraction, its signal level should be commensurate with the signal level of the first electrical signal developed by the transducer 12, thereby requiring little or no level balancing between it and the first electrical signal. The amplified audio output signal may also be used instead of the low level audio input signal. However, this would require amplification of the first electrical signal or attenuation of the audio output signal to balance their respective signal levels.

In one embodiment of the present invention, the processor 16 may develop the dynamic signal data as time sampled values of the first electrical signal. For example, the processor 16 may obtain successive amplitude values of the first electrical signal at regular clock intervals. Each of these values may be represented by an n-bit word. The value obtained at each clock interval may be placed into a parallel shift register (not shown). The parallel shift register may then temporarily store the n-bit word from a selected number of successive clock intervals.

As each new n-bit word is placed into the shift register, the oldest and-bit word is removed from the shift register, as is conventionally known. At each clock interval, the comparator 18 may then compare the contents of the shift register with each store signal data contained within the database 14.

Accordingly, in another embodiment of the present invention, the database 14 may be populated with the stored signal data using the mute trigger apparatus 10 described hereinabove. For example, momentary acoustic wave energy may be developed such as from a ringing telephone, a doorbell or any other type of momentary acoustic wave energy. During the duration of the momentary acoustic wave energy, the transducer 12 develops a first electrical signal, as hereinabove described, which is representative of the momentary acoustic energy.

The processor 16, in response to the first electrical signal developed commensurate with the momentary acoustic energy, develops the dynamic signal data that may now be stored in the database 14. The processor 16 may respond to a user selectable switch wherein the position of the switch determines whether the dynamic signal data is to be stored in the database 14 or compared with stored signal data as described above. In the event that time sampled values are used, a shift register capable of storing n-bit words from a selected number of clock intervals is populated, and the entire contents of the shift register then stored as one item of stored signal data in the database 14. Accordingly, for each clock interval, the present dynamic signal data contained in the shift register may be compared with stored signal data contained in another shift register.

Furthermore, the present invention additionally contemplates that time sampled values of the first electrical signal, whether during operation of the ring trigger apparatus 10 or during population of the database 14, may be filtered or converted to the frequency domain. Such filtering and conversion may utilize known noise reduction techniques to increase recognition between dynamic and stored data. Of course, the techniques used during population of the database 14 should also be used during operation of the mute trigger apparatus 10.

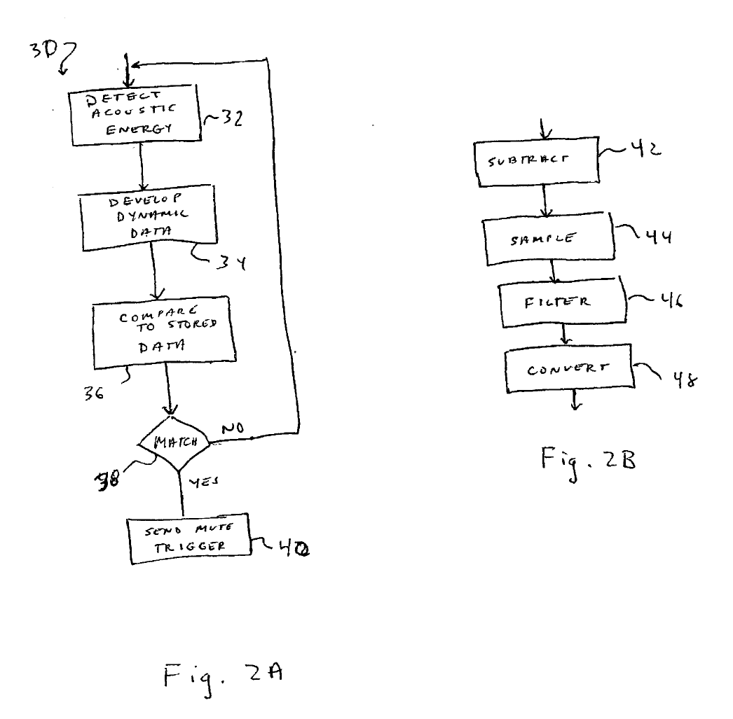

Referring now to FIG. 2A, there is shown a flowchart 30 useful to describe a method according to the principles of the present invention. Acoustic wave energy is detected, as indicated at step 32. As indicated at step 34, the acoustic wave energy is developed into dynamic data. The dynamic data is then compared to stored data, as indicated at step 36.

A decision is made, as indicated at step 38, whether the dynamic data and the stored data match. If NO, a path is taken back to step 32. If yes, a mute trigger is generated, as indicated at step 40.

The developing step 34 may include subtracting continuous wave energy is subtracted from the acoustic wave energy such that momentary wave energy remains, as indicated at step 42. The momentary wave energy is indicative of a sound to trigger a mute.

Referring now to FIG. 2B, the developing step 36 may further include sampling the momentary wave energy, as indicated at step 44. Additionally, the developing step may also include either one or both of filtering the sampled wave energy, as indicated at step 46, and converting the sampled energy into the frequency domain, as indicated at step 48.

There has been described above a novel ring triggered mute apparatus and method. Those skilled in the art may now make numerous uses of, and departures from, the above described exemplary preferred embodiments without departing from the inventive concepts and principles disclosed herein. Accordingly, the present invention is to be defined solely by the lawfully permissible scope of the appended claims.

What is claimed as the invention is:

1. A mute trigger apparatus comprising:
a transducer responsive to acoustic wave energy to develop a first electrical signal commensurate with said acoustic wave energy;
a database containing stored signal data;
a processor responsive to said first electrical signal to develop dynamic signal data; and
a comparator responsive to each of said stored signal data and said dynamic signal data to develop a second electrical signal in the event said stored signal data and said dynamic signal data are substantially equivalent, said second electrical signal being adapted to trigger a mute switch.

2. An apparatus as set forth in claim 1 wherein said dynamic signal data is developed as time sampled values of said first electrical signal.

3. An apparatus as set forth in claim 2 wherein said dynamic signal data is further developed as filtered time sampled values.

4. An apparatus is set forth in claim 2 where in said dynamic signal data is further developed as frequency domain data.

5. An apparatus as set forth in claim 1 wherein said acoustic wave energy includes continuous wave energy and momentary wave energy, said processor being further responsive to said continuous wave energy to subtract said continuous wave energy from said acoustic wave energy such that said dynamic signal data contains information substantially of only said momentary wave energy.

6. An apparatus as set forth in claim 5 wherein said stored signal data is developed from an instance of said momentary wave energy.

7. An apparatus as set forth in claim 6 wherein said transducer in response to said instance develops said first electrical signal commensurate with said instance and said processor in response to said first electrical signal commensurate with said instance develops said dynamic signal data to be stored as an instance of said stored signal data.

8. An apparatus as set forth in claim 1 wherein said second electrical signal is further adapted to trigger response in further electronic devices.

9. In an audio apparatus including a mute switch and an audio output amplifier, said mute switch having an OFF state and an ON state, said audio output amplifier amplifying a low level audio input signal applied thereto to develop an amplified audio output signal when said mute switch is in said OFF state and muting said audio output signal when said mute switch is in said ON state, a mute trigger apparatus comprising:
a transducer responsive to acoustic wave energy to develop a first electrical signal commensurate with said acoustic wave energy;
a database containing stored signal data;
a processor responsive to said first electrical signal to develop a dynamic signal data from said first electrical signal; and
a comparator responsive to said dynamic signal data and said stored signal data to develop a second electrical signal in the event said dynamic signal data is substantially equivalent to said stored signal data, said mute switch being transitionable to said on state in response to said second electrical signal.

10. An apparatus as set forth in claim 9 wherein said dynamic signal data is developed as time sampled values of said first electrical signal.

11. An apparatus as set forth in claim 10 wherein said dynamic signal data is further developed as filtered time sampled values.

12. An apparatus is set forth in claim 10 where in said dynamic signal data is further developed as frequency domain data.

13. An apparatus as set forth in claim 9 wherein said acoustic wave energy includes continuous wave energy and momentary wave energy, said processor being further responsive to said continuous wave energy to subtract said continuous wave energy from said acoustic wave energy such that said dynamic signal data contains information substantially of only said momentary wave energy.

14. An apparatus as set forth in claim 13 wherein said processor is further responsive to each of said audio input signal and said first electrical signal to subtract said audio input signal from said first electrical signal.

15. An apparatus as set forth in claim 13 wherein said stored signal data is developed from an instance of said momentary wave energy.

16. An apparatus as set forth in claim 15 wherein said transducer in response to said instance develops said first electrical signal commensurate with said instance and said processor in response to said first electrical signal commensurate with said instance develops said dynamic signal data to be stored as an instance of said stored signal data.

17. An apparatus as set forth in claim 9 wherein said audio apparatus is further responsive to said second electrical signal to develop an acoustic signal from said stored signal data equivalent to said dynamic signal data.

18. A mute trigger method comprising steps of:
detecting acoustic wave energy;
developing dynamic data from said acoustic wave energy;
comparing said dynamic data to stored data; and
generating a mute trigger in the event said dynamic data and said stored data are substantially equivalent.

19. A method as set forth in claim 18 wherein said developing step includes the step of subtracting continuous wave energy from said acoustic wave energy such that momentary wave energy indicative of a sound to trigger a mute remains.

20. A method as set forth in claim 19 wherein said developing step further includes the step of sampling the momentary wave energy.

21. A method as set forth in claim 20 wherein said developing step further includes the step of filtering the sampled wave energy.

22. A method as set forth in claim 20 wherein said developing step further includes the step of converting the sampled energy into the frequency domain.
